(19) United States
(12) Patent Application Publication
(10) Pub. No.: US 2018/0337495 A1
(43) Pub. Date: Nov. 22, 2018

(54) HomeShield Plug

(71) Applicant: Jhonatan Martinez, Shirley, NY (US)

(72) Inventor: Jhonatan Martinez, Shirley, NY (US)

(21) Appl. No.: 15/600,280

(22) Filed: May 19, 2017

(51) Int. Cl. H01R 13/66; H01R 13/713; H01R 24/30; H01R 24/60; H01R 24/78; H01R 25/00; H01R 27/02

(52) U.S. Cl. CPC H01R 13/6683; H01R 13/713; H01R 24/30; H01R 27/02; H01R 24/78; H01R 25/006; H01R 24/60

(57) ABSTRACT

An electrical device that plugs into power outlets, the apparatus is smart with technology capabilities of detecting motion, detecting temperature and humidity levels. It contains controllable LED night-lights it contains two power outlets. The apparatus Notifies when glass has been broken/shattered, notifies when smoke detector goes off, notifies when Carbon monoxide sounds. All while providing simple and cost effective solutions.

### FIELD OF TECHNOLOGY

The present invention relates to a smart controlling security device in the electrical and home automation field.

### BACKGROUND

Security systems are known and widely used in many homes, commercial, industrial properties to prevent unauthorized entry, theft, property damage, as well as providing personal protection against intruders. Property owners can protect and have a peace of mind knowing what they most value is being protected and cared for. Furthermore, security companies will notify a property owner or renter of any intrusions, fires, or glass break-ins. This has been the practice for many years, unfortunately many properties owners and renters included cannot afford the luxury of a security system and the comfort of a peace of mind. Typically, there is a concern for personal safety of the belongings at home and family, what is offered is just not solving the real issues as many can simply not afford the premium fees or install the equipment themselves. Therefore the present invention is an apparatus which is plugged into a power outlet, helping various consumers tackle tasks of security systems while providing the convenience of home automation, the apparatus provides benefits from one or more sensors with its smart technology, while allowing the user to be informed and control it from anywhere in the world from a smart mobile device.

### SUMMARY

The inventor realized that after owning a home and discussing with other homeowners and renters, those security systems are not affordable to many people. With this in mind, the inventor has devised a smart outlet, the apparatus and systems to improve security. The apparatus has many functions that will be useful to people who want to protect their family, home, pets, and belongings. The apparatus will protect users home, family and personal belongings. The apparatus will inform user if anything out of the ordinary is occurring such as motion detection, high temperatures, high humidity, or any glass break-ins. The apparatus will help deter any criminal activity by preset schedules to randomly turning on lights, appliances, T.V., and radios. Making it seem as if the house is currently being occupied. It will provide with a nightlight for those midnight snack wakings, all while being able to provide all your other devices with power. The apparatus will connect with other smart devices and make your living environment into a safer, more convenient place to live. The present invention has two smart outlets sockets and provides one or more sponsors despised inside the housing.

Various other aspects, advantages, and novel features of the invention are described below or will be readily apparent to those skilled in the art from the following specifications and drawings of illustrative embodiments.

### BRIEF DESCRIPTION OF THE DRAWINGS

This disclosure is further described in the detailed description that follows, with reference to the drawings, in which:

FIG. 1 illustrates the back of apparatus, which displays three slotted openings, power pins, and earth pins.

FIG. 2 illustrates the front of the apparatus, which displays two power sockets and a fresnel lens which hides a motion sensor and photocell sensor.

FIG. 3 illustrates the bottom area of the apparatus, which displays four LED lights.

FIG. 4 is an overview of the apparatus, which displays a power button, one of the two US8 ports, two power outlets and a fresnel lens which hides a motion sensor and photocell sensor.

FIG. 5 illustrates an overview of the apparatus, which displays one of the two USB ports, two power outlets, four LED lights, and a fresnel lens which hides a motion sensor and photocell sensor.

FIG. 6 illustrates the process in which the apparatus performs while connected to a internet network to notify the user.

FIG. 7 illustrates the apparatus motion sensor hidden under the fresnel lens. In which it is sensing the motion triggered by an occupant.

FIG. 8 illustrates the apparatus in multiple locations in an enclosed area. In which the connected apparatus communicate with one another.

### DETAIL DESCRIPTION

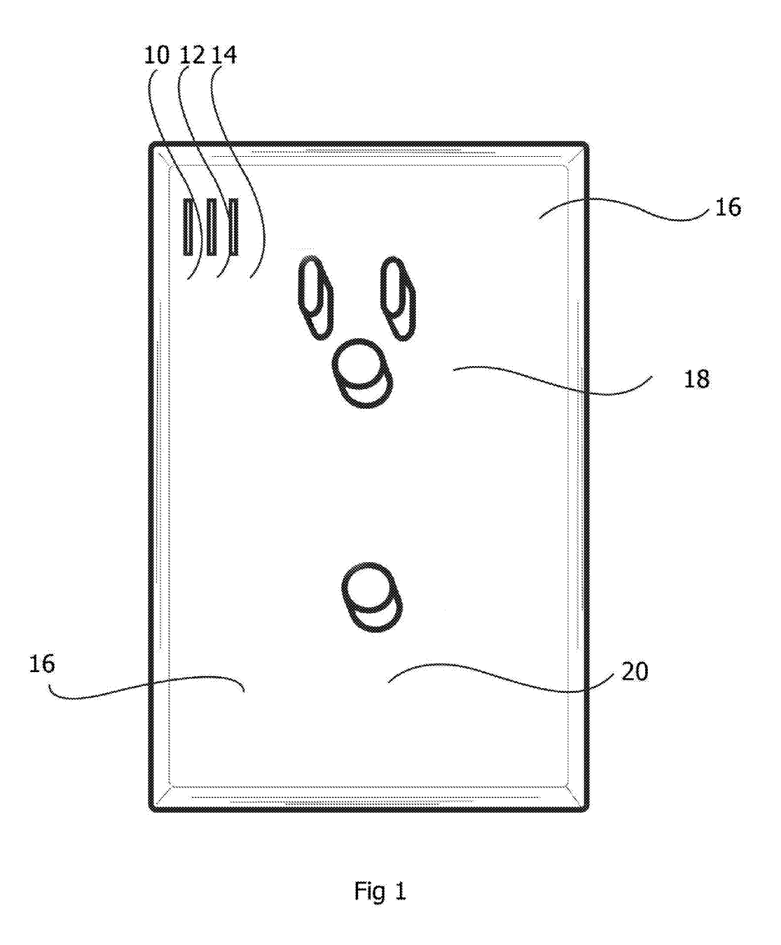

In the following detailed description, for purposes of explanation, numerous specific details are set forth to provide a thorough understanding of the various implementations of the present invention. Those of ordinary skill in the art will realize that these various implementations of the present invention are illustrative only and are not intended to be limiting in any way. Other implementations of the present invention will readily suggest themselves to such skilled persons having the benefit of this disclosure. As shown in FIG. 1, the back view of an apparatus, includes (16) a smart device with fire retardant material, the electrical device also consist of three elongated features (10, 12, 14) to provide ambient air to the device and providing accurate sensor readings, when prongs and pins (18, 20) have contact with wall outlet, plug 18 electrically coupling with pin 20, such as a typical alternating current (AC) power outlet found in many households and businesses. The present invention consist of one or more (20) a contact pin that connects with the wall unit to provide a ground source for the apparatus. All while allowing the electrical device communicates with the controlling main unit through a network.

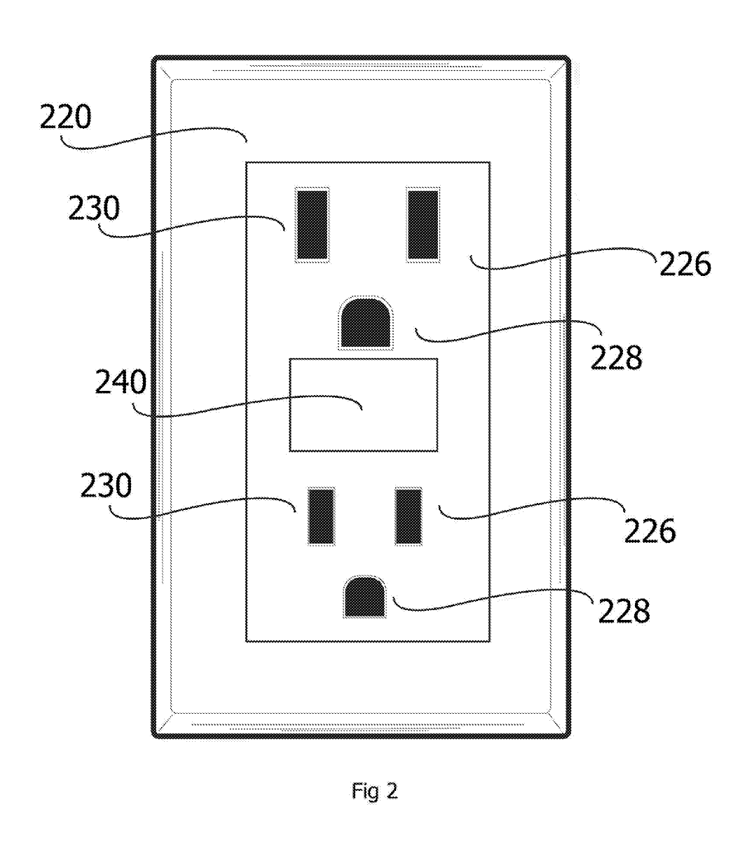

FIG. 2 illustrates a perspective view of present invention forward facing surface while plugged into an electrical outlet positioned. Normally, plugging any electrical device into one or more of apparatus outlets (226, 228, and 230) forms an electrical circuit between the apparatus (220) and the wall outlet, which is coupled to a central power source. In the typical arrangement, actuating a power switch or similar actuator, completes the circuit, allowing electrical current to flow from the apparatus to the smart outlet providing power(226, 228, 230) According to embodiments of the invention, electrical current and hence power, is provided to the apparatus, allowing electrical current to flow, once certain conditions have been satisfied. In some implementations, the apparatus outlets can be controllable through an external remote device.

In addition, some implementations can be programmed through a remote device, allowing the user form schedules, timers, and rules for the PIR motion sensor (240). The Fresnel lens (240) is used to conceal the motion sensor located in FIG. 2 can sense occupants and triggering on any desired power outlet belonging to the apparatus (226,228,230). For example, a night lamp is plugged into apparatus in desired room. The light will turn on when occupant enters, occupant can then turn off or have preset timer to turn off power to lamp. Furthermore, the Fresnel lens (240) provides the motion sensor with optic for the one or more purpose, like used as an intrusion detector. For example, user has set alarm/away mode for apparatus, in case of intrusion; wherein Fresnel lens (240) working with motion sensor has sensed presence and will communicate with device controlling main unit. Resulting in an intelligent notification to its rightful user.

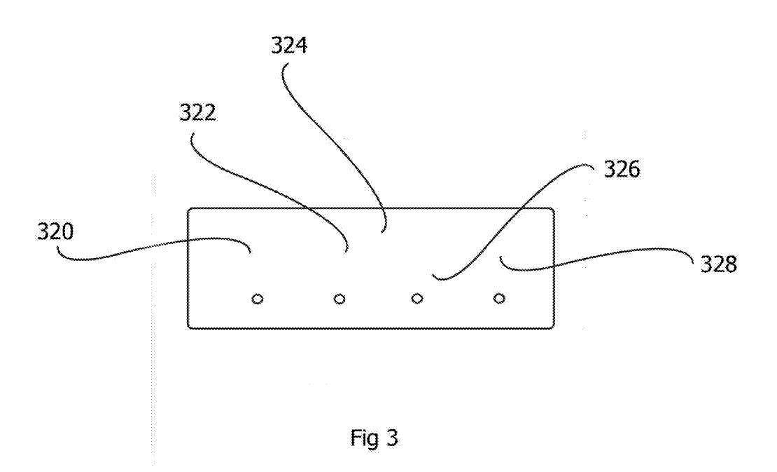

FIG. 3 illustrates sectional view of the embodiment of the present invention; in which it consist of one or more LED (320,322,326,328) lights inside the apparatus housing. The Led lights corresponds to the ambient light sensor disposed inside the housing. The apparatus communicates through the device controlling main unit, providing the user the preference of selecting to automate led lights. In case, the user does not want to automate, they can act accordingly through remote device to power on/off LEDs (324) Consist of the housing for the LED lights housing them equally apart.

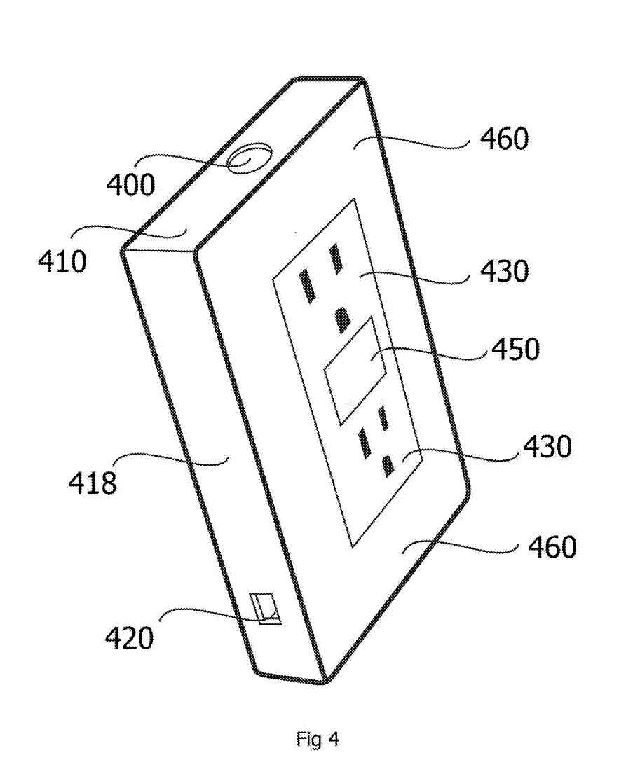

FIG. 4 illustrates another perspective view presenting one or more embodiments in Accordance with implementations of the present invention; the apparatus consist of a power button (400) that acts a physical power source to apparatus. The apparatus housing and surface (410,418,460) consist a fire retardant material. The material meets one or more USB ports (420) on the side. Preferably located on the side for convenience, the USB ports provide power to a user's electrical device. As well as the smart plugs (430) described in FIG. 2. The Fresnel lens (450) also works a beneficial cover to conceal one or more sensors while visually uncluttered design that facilitates ease of use by users.

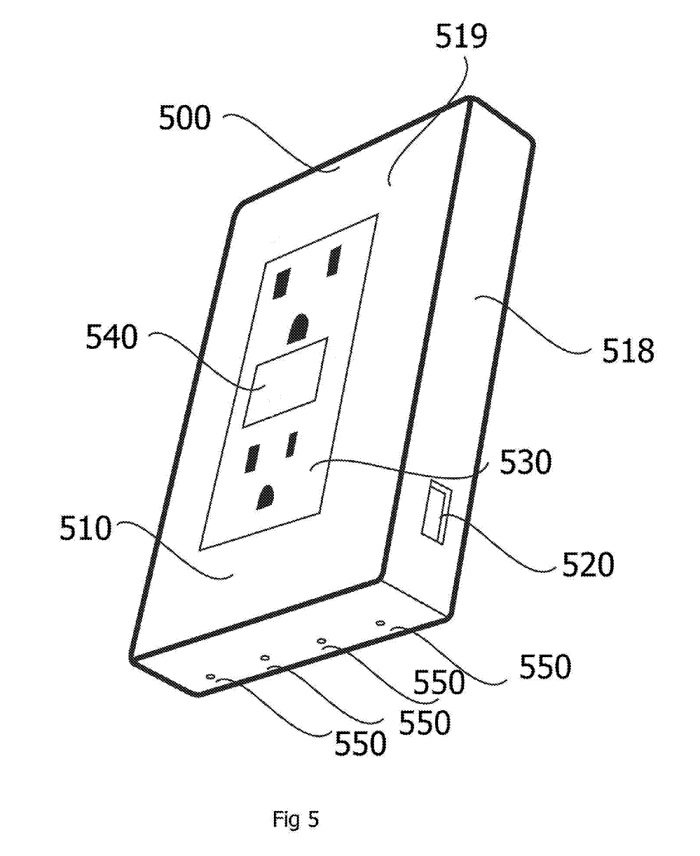

FIG. 5 illustrates another perspective view presenting one or more embodiments in Accordance with implementations, while many of the features were listed in FIG. 4, FIG. 5 presents another angle of the device providing a better imagination of functions, embodiments, and features as a whole. The apparatus consist of another female USB port (520) that also provides convenience and power to users powering their electrical devices, while have the smart plugs available. Also noted, in FIG. 3, The Led lights (550) located in the lower part of the apparatus. While providing a visually concealed design.

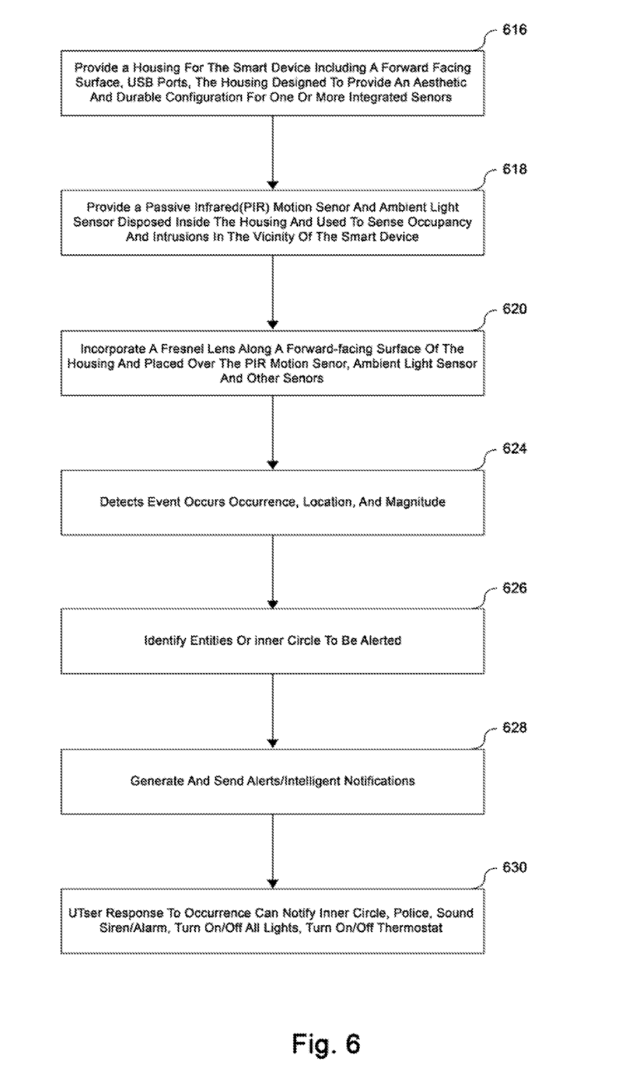

FIG. 6 is flow chart diagram that outlines the operations associated with integrating sensor capabilities with electrical device and sensors in accordance with aspects of the present invention. A flow chart diagram outlines the operations associated with integrating sensor capabilities with a smart outlet with USB ports and a Fresnel lens in accordance with aspects of the present invention. In some implementations, the integration operations include providing a housing for the smart outlet designed to provide an attractive and durable configuration for one or more integrated sensors (616). Housing for the smart outlet may be housing 16 illustrated in FIG. 1 as previously described. The present disclosure is enclosed by the housing with a forward-facing surface for a cover and Fresnel lens in accordance with aspects of the present invention. The one or more integrated sensors protected by the housing may include an occupancy sensor such as a PIR motion detector, USB ports, ambient light sensor, a humidity sensor, Led lights or other sensors that might be useful in operating a smart device. Placing these and other sensors inside the housing protects them from being accidentally jarred or broken during manufacture, shipping, installation or use. Because sensors are protected inside the housing, they are more likely to retain their calibration and provide accurate measurement results for the smart device.

Additionally, the integration operations may also provide a passive infrared (PIR) motion sensor disposed inside the housing and used to sense occupancy near the smart device (618). In some implementations, the PIR motion sensor has a radiation-receiving surface able to Detect the radiation emitted towards the forward-facing surface of the housing by the lateral movement of a nearby occupant. The smart device to better control lighting and save energy or detecting intrusions in an enclosure such as a residential house may use occupancy information detected by the PIR motion sensor. In some implementations, a smart device may use the occupancy information to turn on the lights or lamp when occupancy is detected and off when no occupancy is detected by the PIR motion sensor. In alternate implementations,

The smart device may use the occupancy information generated by the PIR motion sensor as part of an alarm system that learns when an enclosure is likely to be occupied or unoccupied, anticipates an alarm, and disarm feature. This heuristic may use real-time Geo-fencing and other factors combined with learned occupancy patterns to determine when the enclosure needs to arm or disarm. An ambient light sensor disposed inside the housing may also be provided to detect the ambient light near the smart device. The PIR motion sensor and ambient light sensor may be similar to PIR motion sensor 240, ambient light sensor 240 respectively illustrated in FIG. 2 as previously described.

Integration operations in accordance with the present invention may further attach a Fresnel lens along a forward-facing surface of the housing and placed over the PIR motion sensor, ambient sensor and others sensors (620). As previously described, the Fresnel lens may substantially conceal and protects the PIR motion sensor disposed inside the housing. Concealing the PIR motion sensor promotes a visually pleasing quality of the smart device as well as protects the PIR motion sensor during manufacture, shipment, installation and use. In some implementations, the Fresnel lens may be similar to grille member 240 previously described and illustrated in accordance with FIG. 2. In some implementations, Fresnel lens coupling the PIR motion sensor to the assists with the radiation-receiving surface able to detect the radiation emitted on the forward-facing surface of the housing by the lateral movement of a nearby occupant.

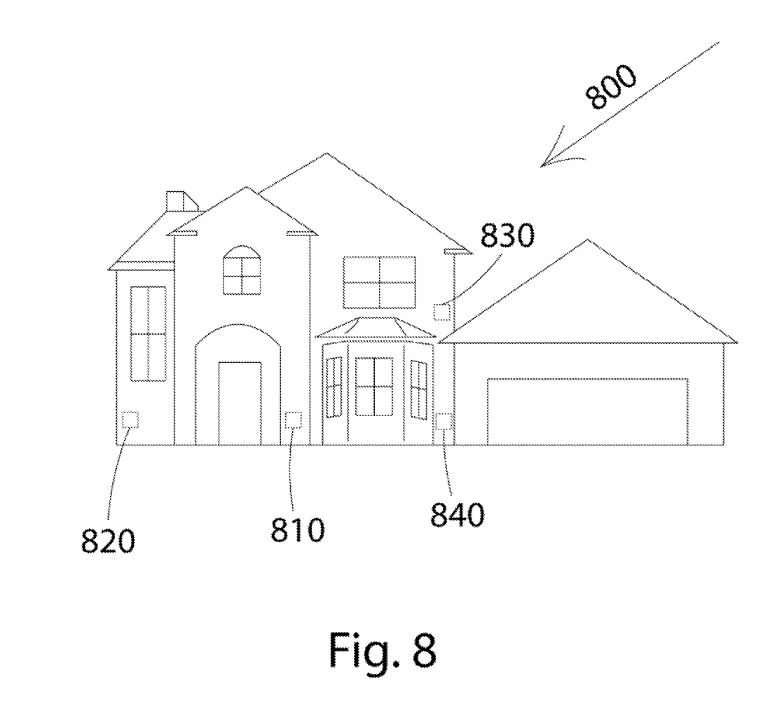

In addition, in case of an event occurrence(624) in an enclosure 800 described and illustrated in accordance with FIG. 8, the smart device 220 will identify entities or pre-set inner circle of close friends and family(626). The smart device 220 with then generate and send alerts and smart notifications (628) to the user's remote device. All while allowing the user to respond to react to event occurrence remotely depending of current situation (630).

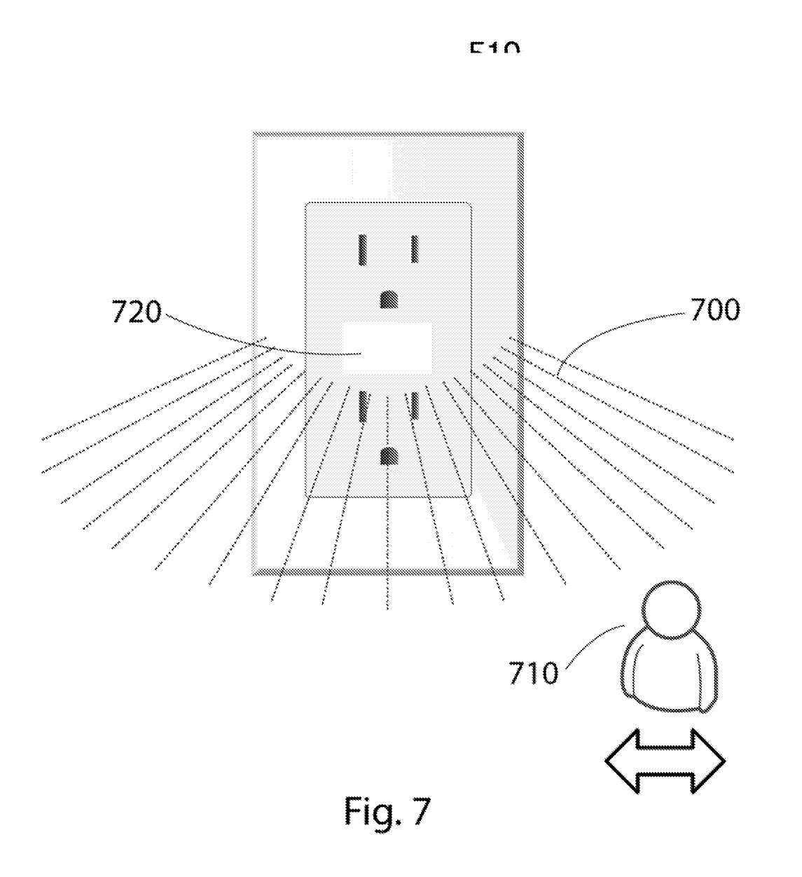

FIG. 7 illustrates an occupant's movement detected due to infrared sources interacting with the Fresnel lens designed in place of the present invention. The image depicts an occupant that has been sensed, resulting in turning on power for a pre-set time, a smart real time notification of an intrusion to remote device, and the benefit of energy savings. The Fresnel lens 720 covering the motion sensor and ambient sensor (not shown in FIG. 7) to adjust to shadows and false alarms. The PIR motion sensor sits behind Fresnel lens 240 as shown in FIG. 2. The PIR motion sensor is capable of detecting a lateral change of radiation 700 caused by a laterally moving source of infrared radiation such as a person walking in a room. To make the occupancy detector work properly, these lateral changes in radiation 700 caused by the occupant 710 must be distinguished from overall changes in the infrared radiation caused by sunlight and ambient heat sometimes referred to as the common-mode signal.

In some implementations, the PIR motion sensor has a pair of differential sensing elements setup with opposing polarity to reject the common-mode signal produced by radiation 700. When occupant 710 is not present or not moving, sudden overall changes in radiation 700 caused by sunlight, heat or vibration produce complementary signals from the pair of differential sensing elements simultaneously. The complementary signals from the pair of differential sensing elements immediately cancel out these false positive or common-mode signals.

In comparison, an occupant 710 moving laterally in the direction of the arrows in FIG. 7 across a room or other space near the smart device 16 creates a local change in radiation 700. The local change in radiation 700 is detected and not canceled out with the common-mode signal portion of radiation 700 as the sensing elements are arranged along a horizontal axis and triggered sequentially, not simultaneously, by the lateral movement. Because PIR motion sensor has a Fresnel lens, 240 that is able to detect the radiation emitted towards its surface of the housing by the lateral movement of a nearby occupant. Forward-facing surface directs radiation 700 return to Fresnel lens 240 and is detected by PIR motion sensor whether the occupant 710 is moving laterally from the far right; far left or laterally near the center area near the thermostat.

FIG. 8 is a diagram illustrating an exemplary enclosure using a smart device 810, implemented in accordance with aspects of the present invention for controlling one or more devices and environment conditions. Indicating in any situation where the user places the present invention into an existing wall power outlet, for example, enclosure 800 illustrates a single family dwelling type of using smart device 810 for the control of security, home automation and LED lights. Alternate implementations of the present invention may be used with other types of enclosures including a duplex, an apartment within, an apartment building, a light commercial structure such as an office or retail store, or a structure or enclosure that is a combination of these and other types of enclosures benefit from a smart safer, secure environment.

Some implementations of smart device 810 in FIG. 8 incorporate one or more sensors to gather data from the environment associated with enclosure 220. Sensors incorporated in smart device 810 may detect occupancy, temperature, light and other environmental conditions and influence the control and operation of heating/cooling, lighting, and electrical system. The smart device 810 uses a Fresnel lens (not shown in FIG. 8) implemented in accordance with the present invention to cover the sensors. In part, the Fresnel lens of the present invention adds to the appeal and attraction of the smart device 810 as the sensors in smart device 810 do not protrude, or attract attention from occupants of enclosure 800 and the smart device 810 fits with almost any decor. Keeping sensors within smart device 810 also reduces the likelihood of damage and loss of calibration during manufacture, delivery, installation or use of smart device 810. Yet despite covering these sensors, the specialized design of the Fresnel lens facilitates accurately gathering occupancy, light and other data from the environment. Further details on this design and other aspects of the grille member are also described in detail later herein.

In some implementations, there could be one or more smart device 810, 820, 830, 840 within an enclosure 800. The smart devices 810, 820, 830, 840 can wirelessly communicate with one another gathering information. The smart device 810 can share it's the data with user's remote device, displaying information to user, while a second smart device 820 can receive the provided data input to create a smart environment. For example, in the case of an intrusion, smart device 810 is under alarm mode as well as other smart devices 820, 830, 840, once user has left enclosure 800, the smart device 810 detects an intruders occupancy 710 as shown in FIG. 7, forwarding data input to smart devices 820, 830, 840, which then turn on pre-set lights or lamps. Like smart device 810, implementations of second smart device 812 may also include sensors to gather data related to occupancy, temperature, light and other environmental conditions. A

Fresnel lens (not shown in FIG. 8) designed in accordance with the present invention may also be used to conceal these sensors maintaining an attractive and pleasing appearance of smart device 810 within the enclosure 800. In an alternate implementation, one or more smart devices 820, 830, 840 may also be located outside of the enclosure 800.

The present disclosure is a controllable energy-efficient and smart, state of the art security system, home automation, nightlight and monitoring Technology power outlet. Smart and controllable of impending events can be useful and beneficial in many ways. For example, sensing someone enter a room and even when severe events occur. The apparatus will warn you when necessary to protect belongings from the damage. As another example, timely notifications impending events, even if provided only a few seconds in advance, can prevent loss of valuables, injury or death by allowing recipients respond quickly to alarm notification, notify police, sound siren, notify circle, and turn on all lights. Even dealing with less severe events can result in substantial advantages. For example, if a person's actions can be reliably predicted, other related people can more efficiently plan their activities and/or particular conveniences can be

Appropriately timed to be ready upon the person's arrival at a location. Utilization of such advantages could improve productivity, safety, and comfort on many different scales and in many different ways.

Accordingly, the invention is not limited to the above-described implementations, but instead is defined by the appended claims in light of their full scope of equivalents.

1. A electrical device comprising:
A housing including a forward-facing surface with power sockets, configured for set of power pins of a smart plug to plug into; a driving pin and a set of detection pins, configured for forming a circuit with a set of feedback pins of a smart plug when the set of power pins is plugged into the power sockets; and an identification code module, configured for obtaining an identification code of an electric appliance, from the circuit, to which the smart plug belongs.

2. The smart socket as claimed in claim 1, further comprising at least two socket pins, wherein the power pins electrically connect to a power source via the at least two socket pins.

3. The smart socket as claimed in claim 1, further comprising an adapting pin which electrically connects to a power source through plugging into a normal socket.

4. The smart socket as claimed in claim 1, further comprising a network module for transmitting the identification code to a network.

5. The smart socket as claimed in claim 1, wherein the detection pins are insulated from the power pins.

6. The smart socket as claimed in claim 2, further comprising a safety switch for controlling the Connection between the socket pins and the power source, wherein the safety switch is turned on or off corresponding to the identification code.

7. A smart socket, comprising:
A housing including a forward-facing surface;
A passive infrared (PIR) motion sensor disposed inside the housing, used to sense intrusions and Occupancy in the vicinity of the apparatus, the PIR motion sensor having a radiation receiving surface and being able to detect the lateral movement of an occupant in front of said forward-facing surface of said housing; one or more temperature sensors disposed inside the housing; and a Fresnel lens optic over the radiation receiving surface of the PIR motion sensor, wherein: at multi sensors are disposed inside the housing, the Fresnel lens optic is on the forward-facing surface, and the Fresnel lens substantially conceals and protects both the PIR motion sensor and an ambient light sensor disposed inside the housing, whereby the concealment of the PIR motion sensor by the Fresnel lens optic promotes a visually pleasing quality of the electrical device yet permits the PIR motion sensor to effectively detect the lateral movement of the occupant.

8. The electrical device of claim 7, wherein said Fresnel lens is substantially horizontal direction corresponding to the lateral movement of the occupant.

9. The electrical device of claim 7, wherein the Fresnel lens facilitates the ambient sensor's ability to measure light outside of the housing.

10. The electrical device of claim 7, wherein the Fresnel lens is comprised of a material having high thermal conductivity.

11. The electrical device of claim 7, wherein the Fresnel lens in the forward-facing surface of the housing may be used control the PIR motion sensor's sensitivity to the height of occupants by varying a vertical span of one or more elongated features on the Fresnel lens optic that pass the emitted radiation to the receiving surface of the PIR motion sensor.

12. The electrical device of claim 11, wherein the Fresnel lens optic incorporated in the forward-facing surface of the housing may be used control the PIR motion sensor's sensitivity to the height of occupants by changing a number of the elongated features that pass infrared radiation to the receiving surface of the PIR motion sensor.

13. The electrical device of claim 7, wherein the Fresnel len incorporated in the forward-facing surface of the housing further comprises a mask member attached to a back portion of the Fresnel lens optic, wherein the sensitivity to the height of occupants may be varied depending on the coverage by the mask member of the elongated features used to pass the emitted radiation to the receiving surface of the PIR motion sensor.

14. A method of integrating occupancy sensing capabilities in a electrical device, comprising:
providing a housing for the electrical device including a forward-facing surface;
providing one or more sensors disposed inside the housing; providing a passive infrared (PIR) motion sensor disposed inside the housing and used to sense occupancy in the vicinity of the electrical device, the PIR motion sensor having a radiation receiving surface and being able to detect the lateral movement of an occupant in front of said forward-facing surface of the housing; and attaching a cover lens to occupy a void in the forward-facing surface of the housing and placed over the radiation receiving surface of the PIR motion sensor, wherein: an ambient sensor is coupled to said cover member, the cover member substantially conceals and protects both the PIR motion sensor and an ambient sensor disposed inside the housing promoting a visually pleasing quality of said electrical device, and whereby one or more elongated features in the cover member enables the PIR motion sensor to detect lateral movement of an occupant in front of said forward-facing surface of the housing of the electrical device. Detection resulting in said sensor sending information is set through a connected network to communicate with the controlling device main unit.

15. The method of claim 14, wherein is set through a connected network to communicate with the controlling device main unit, allows the communication between apparatus and external device.

16. The method of claim 15, wherein the communication between apparatus and external device allows the user to react to intrusion if alarm set.

17. The method of claim 14, wherein said sense occupancy in the vicinity of the electrical device, facilitates the PIR motion sensor's ability to detect movement and communicate with controlling device main unit.

18. The method of claim 17, further compromising of switching on electrical device smart plugs when movement has been detected.

19. The method of claim 14, wherein the cover member incorporated in the forward-facing surface of the housing further comprises a mask member attached to a backside portion of the cover member, wherein the sensitivity to the height of occupants may be varied depending on the coverage by the mask member of a plurality of substantially horizontal elongated features used to pass infrared radiation to the receiving surface of the PIR motion sensor.

20. The method of claim 14, wherein at least one of the elongated features has an optical property different from a remainder of the cover member.

21. The method of claim 14, wherein the apparatus is connected network to communicate with the controlling device main unit, switches on programmed switch each time said sensor detects motion.

22. The method of claim 14, wherein the apparatus is connected network to communicate with the controlling device main unit, switches on programmed led nightlights each time said sensor detects motion.

23. The method of claim 22, wherein said Led nightlights turn on when communicating with controlling device main unit.

24. The method of claim 23, wherein said Led nightlights turn on when ambient light sensor detects light is not present.

25. The method of claim 24, wherein said ambient light sensor detects light is not present, communicates with the controlling device main unit.

26. A method of sensing capabilities in a electrical device, comprising: providing a housing for the electrical device including a forward-facing surface; providing one or more sensors disposed inside the housing; providing a temperature and humidity sensor that would take readings from ambient air and process data inside the electrical device.

27. The method of claim 26, wherein the temperature and humidity sensor send information is set through a connected network to communicate with the controlling device main unit.

28. The method of claim 27, wherein the temperature and humidity sensor send information through a connected network to communicate with the controlling device main unit, providing display of data

29. The method of claim 28, wherein display of data is displayed, user can command to set targeted temperature and humidity to correspond to desired environment.

30. The method of claim 26, wherein temperature sensor sense severe temperature will communicates with the controlling device main unit.

31. The method of claim 30, wherein temperature sensor sense severe temperature and communicates with the controlling device main unit, further comprising an notification to users external device.

32. The method of claim 26, wherein humidity sensor sense severe humidity will communicates with the controlling device main unit.

33. The method of claim 32, wherein humidity sensor sense severe humidity and communicates with the controlling device main unit, further compromising an notification to users external device.

34. A method of sensing capabilities in an electrical device, comprising: providing a housing for the electrical device including a forward-facing surface; providing one or more sensors disposed inside the housing; providing a glass breaker sensor inside the housing and used to sense broken glass or shattered windows while in the vicinity of the electrical device, the glass breaker sensor having a microphone receiving frequency and being able to detect glass breaking.

35. The method of claim 34, wherein glass breaker sensor used to sense broken glass or shattered windows, further compromising of communicating with the controlling device main unit.

36. The method of claim 35, further compromising of notifying a user of possible break-in.

37. A method of integrating occupancy sensing capabilities in a electrical device, comprising:
providing a housing for the electrical device including a forward-facing surface;
providing one or more sensors disposed inside the housing; providing a siren inside the housing and used to as a deterrent that discourages or is intended to discourage someone from doing something while in the vicinity of the electrical device, the siren having a loud frequency and being able to have deter effect on intended intruder.

38. The method of claim 37, wherein siren communicates with the controlling device main unit, further compromising an loud frequency.

39. A method of smart powering capabilities in a electrical device, comprising: providing a housing for the electrical device including a forward-facing surface; providing one or more female smart sockets disposed inside the housing; providing female powering smart sockets inside the housing and used to charge external devices while controlling from external device.

40. The method claim 39, wherein smart sockets capable charging external devices while in the vicinity of the electrical device, further compromising of communicating with the controlling device main unit.

41. The method claim 40, further compromising of communicating with the controlling main unit allows smart sockets to be power from external device. Configured to set on/off devices

42. The method claim 41, wherein configure to set on/off devices, further compromising of programming vacation mode. configured to set automate devices randomly throughout the day and week

43. A method of powering capabilities in a electrical device, comprising: providing a housing for the electrical device including a forward-facing surface; providing one or more female USB ports disposed inside the housing; providing female USB port inside the housing and used to charge external devices. Capability of charging external devices while approximately the electrical device.

44. The method of claim 43, further compromising of charging external electrical devices while leaving available electrical outlets.
